(19) United States
(12) Patent Application Publication
(10) Pub. No.: US 2002/0143711 A1
(43) Pub. Date: Oct. 3, 2002

(54) Method and system for performing and providing notary services and verifying an electronic signature via a global computer network

(76) Inventor: Nicholas N. Nassiri, Los Angeles, CA (US)

Correspondence Address: Nicholas N. Nassiri, 11222 La Cienega, #150, Inglewood, CA, 90304, US

(21) Appl. No.: 10/097,061

(22) Filed: Mar. 12, 2002

Related U.S. Application Data
(63) Continuation-in-part of application No. 09/818,047, filed on Mar. 27, 2001.

(51) Int. Cl. G06F 17/60; H04L 9/00; H04K 1/00

(52) U.S. Cl. 705/76

(57) ABSTRACT

The method and system of the present invention function to provide and perform signature verification services by a live notary public via the internet or other TCP/IP based network using a paperless document platform, a notary public, traditional notarization processes and methods, an electronic notary seal input device, and an electronic notary journal device. The present invention makes possible the electronic capture of a handwritten signature and the electronic capture of a notary seal and a notary jurat which are affixed to an electronic document; upon affixing the electronic signatures and electronic notary seal an electronic notary journal is created for future reference and possible dispute resolution.

### PRIOR APPLICATIONS

This application claims the benefit of pending patent application entitled, “Method Of And System For Providing And Performing Notary Services and Verifying A Digital Signature Via A Global Computer Network” by Inventor Nicholas N. Nassiri, and referenced as docket number 32,870.001, with respect to the application's a method of signature verification using a notary public, electronic documents and the internet.

### BACKGROUND OF THE INVENTION

### Copyright Notice

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

1. Field of the Invention

The present invention generally relates to the field of signature and identity verification with respect to on-line electronic commerce transactions. More particularly, the present invention relates to a method and system for providing signature and identity verification using a notary public and an electronic method of notarization.

2. Description of the Prior Art

With the advent of e-commerce, electronic signatures and methods thereof have taken precedence in modern business practice. It is a reality that modern business mandates means by which one may legally transact and consummate business electronically on-line. To this end, there exist various methods by which one may affix an electronic signature in e-commerce; the electronic equivalent of one's manual penmanship. The prevailing prior art reveals methods of affixing one's signature electronically by way of signing one's signature digitally using a digital certificate.

Digital signatures are created and verified by cryptography, the branch of applied mathematics that concerns itself with transforming messages into seemingly unintelligible forms and back again. Digital signatures use what is known as “public key cryptography,” which employs an algorithm using two different but mathematically related “keys;” one for creating a digital signature or transforming data into a seemingly unintelligible form, and another key for verifying a digital signature or returning the message to its original form. Computer equipment and software utilizing two such keys are often collectively termed an “asymmetric cryptosystem.” To verify a digital signature, the verifier must have access to the signer's public key and have assurance that it corresponds to the signer's private key. However, a public and private key pair has no intrinsic association with any person; it is simply a pair of numbers. Some convincing strategy is necessary to reliably associate a particular person or entity to the key pair. In a transaction involving only two parties, each party can simply communicate (by a relatively secure “out-of-band” channel such as a courier or a secure voice telephone) the public key of the key pair each party will use. Such an identification strategy is no small task, especially when the parties are geographically distant from each other, normally conduct communication over a convenient but insecure channel such as the Internet, are not natural persons but rather corporations or similar artificial entities, and act through agents whose authority must be ascertained.

The prior art reveals the following six (6) prior art patents are found to be related to the field of electronic signatures using a digital certificate or some form of public key cryptography.

1. U.S. Pat. No. 5,742,685 issued to Berson et al. on Apr. 21, 1998 for “Method For Verifying An Identification Card And Recording Verification Of Same” (hereafter the “Berson Patent”). The Berson Patent discloses a method for verifying an identification card and recording verification of the same. The identification card includes information on a first portion of the card, the information including personal information relating to the person to be identified, and an encrypted representation of at least part of the information on a second portion of the card, the part including the personal information. The encrypted information can be read from the card and then decrypted to obtain a decrypted representation. The card is then verified by comparing the decrypted representation of the information with the information on the first portion of the card and the personal information is stored as at least part of a record of the verification transaction. The Berson Patent further discloses a record system which includes a source identification such as a machine number and a secure tamper proof clock.

2. U.S. Pat. No. 5,912,974 issued to Holloway et al. on Jun. 15, 1999 for “Apparatus And Method For Authentication Of Printed Documents” (hereafter the “Holloway Patent”). The Holloway Patent discloses an apparatus and method for authentication of printed documents. The printed documents are scanned and digitized using a conventional scanner. The scanned and digitized document contents are edited before being used to generate a digital signature. This allows reading errors which could invalidate a subsequent verification process to be corrected. Using the editor and an input device, the signing authority identifies on the screen different segments of the document. Each segment contains data of a single type and selects a set of rules, among a group proposed by the system, for authenticating the document. Then, for each segment, an edited digital form of the data contents is derived using the method defined in the rules. A hash value of the rules used and the edited digital form of the segment contents is calculated using a public hashing algorithm. Then the apparatus generates a digital signature of the edited digitized segment contents using the secret key of the authenticator. Finally, an authentication code comprising the edited digital form of each segment and the digital signature is printed on the document. To verify the authenticity, the printed document is scanned and digitized again and the digital signature is checked by using the associated public key. If the check fails, the verifier identifies which segment has been scanned differently, comparing it with the related edited digital form in the authentication code printed on the document to evaluate its validity.

3. U.S. Pat. No. 5,872,848 issued to Romney, et al. on Feb. 16, 1999 entitled, “Method and apparatus for witnessed authentication of electronic documents.” The Romney patent consists of a method and apparatus for authenticating an electronic document using an electronic document authenticator. An electronic document authenticator is an individual or enterprise that has been authorized by the inventor witness a digital signature. The Romney patent does not use a licensed notary public nor does the Romney patent perform a method of notarization. Rather, the Romney patent is a form of public key encryption verification whereby the customer enters a digital code, presumed to be the equivalent of his or her written signature, in the presence of the authenticator. The authenticator verifies the digital certificate belongs to the customer that used it by using a corresponding public key provided by the same customer. The Romney patent essentially ascertains that the public key supplied to the authenticator by the customer matches the private key used by the customer to produce the digital signature. The Romney patent fundamentally is a solution to deal with one of the most common problems associated with public key cryptography: identity theft. It is not a form or method of traditional notarization. The Romney patent is premised on the issuance of digital certificates to be used by all parties, including the authenticator, to attest to the veracity of a document, as opposed to the authenticity of an identity and corresponding signature, per the method of a traditional notarization performed by a licensed notary public.

4. U.S. Pat. No. 5,926,551 issued to Dwork et al. on Jul. 20, 1999 for “System And Method For Certifying

Content Of Hard-Copy Documents” (hereafter the “Dwork Patent”). The Dwork Patent discloses a system and method for certifying content of hard-copy documents. A digital representation of the data object is produced, typically, for hard-copy documents to produce a two dimensional bit map. Then, a signature for the digital representation is obtained from a certifying agent. The signature is produced as a function of the digital representation of the data object, so as to reflect the content of the data object. This will commonly be performed by a certifying agent, such as a post office clerk or a notary public. As a result, a representation of the signature, along with the data object is provided. Accordingly, it is established that the signature authenticates the content of the data object.

5. U.S. Pat. No. 5,940,187 issued to Berke on Aug. 17, 1999 for “Method For Certifying Facsimile Communication Over A Telephone Network” (hereafter the “Berke Patent”). The Berke Patent discloses a method for certifying facsimile communications over a telephone network. The method includes a registration sequence during which an originator of facsimile messages establishes an account with the certifying system by providing a handwritten signature and identifying data. The handwritten signature is linked to the identifying data, and the identifying data is utilized through the method in an effort to insure the authenticity of facsimile messages certified by the certifying system.

6. U.S. Pat. No. 5,973,731 issued to Schwab on Oct. 26, 1999 for “Secure Identification System” (hereafter the “Schwab Patent”). The Schwab Patent discloses a secure identification system for providing a secure interactive communication of text and image information between a central server computer and one or more client computers, located at remote sites for the purpose of storing and retrieving files describing an identifying unique products, services or individuals.

7. U.S. Pat. No. 6,314,517 issued to Moses, et al, on Nov. 6, 2001 for “Method and system for notarizing digital signature data in a system employing cryptography based security”. The Moses Patent discloses a method and system for notarizing digital data, such as digital signature data, using a subscriber compromised distribution latency period prior to authenticating the digital data. The essence of the Moses patent, is that upon receiving a notarization request, the system and method stores the digital data for notarization and holds the evidence or digital data for the latency period and as such waits to notarize the digital data in response to the subscriber compromise distribution latency period. That is, the Moses patent acts as an independent third party that intervenes to hold the signature (the digital data) in limbo for the subscriber compromise distribution latency period, as prescribed by the issuing certification authority. Upon expiration of the subscriber compromise distribution latency period, the digital data (the signature) is deemed to be valid, and notarization of the digital data is authorized. Notarization is in the form of a a notary token issued after the latency period has lapsed.

While the prior art is founded on well established principles and methods of public key cryptography, such methods are nonetheless not well-suited to particular types of transactions, especially highly sensitive or high value transactions. Accordingly, transactions such as mortgages or high end financing have largely been precluded from conducting business on-line. The primary problems with PKI for such type of transactions is two-fold: the first, as stated above, is identity theft. The second is legal enforceability of a digital certificate signature. Despite changes in legislation enabling digital signatures as enforceable, the reality is that electronic signatures in the form of digital certificates are used primarily for agreements with relatively short life spans. A mere few years is typical for document retention, and little or no archiving is done. In these cases, signature-validation credibility is not an issue.

Financial and real property documents present a different set of issues that digital certificates are largely unable to redress. Many of these type documents are archived for a few decades at minimum. By law, some must even be archived for years after the signer's death. The issue then arises: how does one discern the validity of a digital certificate many years from its inception. Not even conservative estimates provide any trust when detecting forged electronic signatures—created with today's keys—in some distant future. Therein lies the concern. Thirty years from now, just about anyone could produce an electronically signed financial instrument, using the key you got during the dawn of electronic signatures, and claim payment. The only protection would be to demand the evidential trail. It doesn't matter if you used your private key to sign only short-lived purchasing documents. You need have signed only one for some yet-to-be-born hacker to regenerate your private key with a futuristic personal digital assistant.

Even legislation designed to smooth the transition to electronic signatures, or e-sign, can't erase the legal concerns surrounding it. While such legislation may reduce business and consumer risk, those involved in e-commerce continue to watch for any legal challenges to e-sign, as well as the resulting precedents the future holds. Two criteria establish the evidential trail of a document: the validity of the signature and the time of the signature. The validity of ink signatures is established through notaries and expert analysis; the validity of electronic signatures is established through mathematical and computational principles. It has been well-documented that an electronic signature that is computationally sound today will may be so in a number of years.

The bottom line is, that in court, the burden of proof has and will continue to rest on the recipient of the signature. While the law now says that an electronic or digital signature is valid, an individual or company must nonetheless be reassured the right person signed under legally acceptable conditions, an assurance even biometrics cannot prove. Such continuing uncertainty is why experts say they do not believe the digital signature will replace the notary.

The notary function has a twofold purpose beyond identification of the signer. One purpose is judging the signer's mental competence and comprehension, while the other is to assure the signature was not given under duress. For hundreds of years, society has placed great importance on the ceremonial aspects of document signing. There clearly exists a need to bridge the anonymous nature of electronics with something a human being can relate to as a significant act, and one that ensures legal enforceability.

As the future of the validity of digital signatures remains to be seen, transactions involving real property or financial commitments have been largely unable to take advantage of on-line electronic commerce because of the preemptive legal/business practice requirement that a notary public authenticate the signature to bind the transaction. To date, there exists no integrated solution whereby these types of transactions can be conducted on3 line that encompasses the necessary component of in-person signature verification to conclude the transaction.

Although there exist solutions that claim to provide on-line “notarized” signature verification, such solutions do not comply with the standards and processes of a duly notarized signature. Notarization, legally and traditionally, requires an independent, in-person verification of the identity and signature using a live commissioned notary public who affixes a notary seal and jurat as a means of authentication.

As indicated in the prior art, existing products and 219,_solutions that state to be electronic “notaries” are not notarizations in the traditional sense of the word.

Existing products and solutions typically use code-based digital certificates issued by a licensed certification authority as a means to verify a signature. In reality, a person's signature is converted to a digital code and a person's identity is verified a single time when the digital certificate is issued, not when it is used. The end result being that a signatory may use the digital certificate to unilaterally affix a “notarized” signature to an electronic document, when in fact a notary is not present, nor has a notary verified the identity of the signatory. While the certification authority may be capable of issuing a certificate that corresponds to an applicant, it is unable to verify the identity of the person who is signing the electronic document at the time the digital certificate is used.

The present invention seeks to resolve the primary concerns that precludes sensitive or high-value transactions from being conducted on-line: identity theft and legal enforceability. To this end, the present invention bridges the gap between the need to conduct notarized transactions on-line and the need for identity verification and legal enforceability. The latter necessarily being an upshot of the former. The present invention devises a method of electronic signature verification using the legal enforceability and security of a notary public. The present invention comprises a method heretofore not disclosed in the prior art of electronic notarization that uses a notary public and that is not a public key cryptography based method of notarization. The method and system on the present invention ensures that the notary public is present at the time the electronic document is signed, and that the actual, graphical hand-written signature of the signer is captured, thereby verifying the signatory's intent. Such electronic documents shall bear the traditional notary seal and jurat, in addition to the graphical, hand-written signatures of the signer and the notary public.

Likewise, the ability of the present invention to enable such type of transactions as a mortgage or financing to be consummated electronically is of enormous additional benefit. Processing and closing certain paper based transactions such as a mortgage or a loan application is a well-known but complex process that involves many separate entities, diverse parties and involves multiple documents to consummate the transaction.

Likewise, preparing, transferring and delivering the paper documents for signature on such document-laden transactions remains an expensive, slow, paper-based, offline process. The problems of excess documents and lapses in time are compounded by the fact that the parties to such type transactions are typically numerous and geographically dispersed. Therefore, such type transactions incur considerable amounts of time and money to transport the necessary documents between the geographically dispersed parties. Sometimes, the diverse locations can be as far as cross-country or international. If changes are made to the documents at hand, more time and money are lost while the documents are shipped back and forth for review by the signatories. Upon completion of the documents, the signatories must then sign the documents to such type transactions in front of a notary public to ensure legal enforceability of the transaction.

A major problem to conducting electronic commerce that requires signature verification, is that to date there exists no method whereby the identity of a signer using a digital certificate can be unequivocally ascertained as the person the signer purports to be.

A major problem to conducting electronic commerce that requires signature verification, is that to date there exists no method whereby electronic documents can be electronically notarized using the traditional and legally binding method by a live, licensed notary public.

A major problem to conducting electronic commerce that requires signature verification, is that to date there exists no method whereby electronic documents can be electronically notarized using a licensed notary public seal and jurat.

A major problem to conducting electronic commerce that requires signature verification, is that to date there exists no method whereby electronic documents can be electronically notarized using the graphical, hand-written signatures of the signatories.

A major problem to conducting electronic commerce that requires signature verification, is that to date there exists no method whereby electronic documents can be unequivocally legally enforced years after the time of signature, by way of an independent notary seal and jurat.

A major problem to conducting electronic commerce, is that to date there exists no method whereby electronic documents notarized using a paperless document platform that eliminates the need to physically transport documents to be signed and notarized.

A major problem to conducting electronic commerce, is that to date there exists no method whereby electronic documents notarized using a paperless document platform that eliminates the need for the parties to physically travel to remote locations for documents to be signed and notarized.

It is therefore edesirable to provide a new method and system for providing signature verification with the capability of signing and notarizing electronic documents at remote locations without the need to physically transport the hard copies of such documents to the remote locations to be signed by the signatories and notarized b a notary public. While the devices created by the prior art may be suitable for the particular purpose to which they address, they are not as suitable for signature verification for electronic commerce transactions that typically require the traditional form and security of an in-person notarization.

In view of the foregoing disadvantages inherent in the known prior art, the present invention provides a new method for providing and performing notary services on-line with the capability of electronically transporting, signing and notarizing the electronic documents. In this respect, the method of signature verification with the capability of electronically transporting, signing and notarizing the electronic document according to the present invention, substantially departs from the conventional concepts and designs of the prior art, and in so doing provides an apparatus primarily developed for the purpose of performing notary services via the Internet with the capability of electronically signing and notarizing the electronic document at a remote location. Further novel features and other objects of the present invention will become apparent from the following detailed description, discussion and the appended claims, taken in conjunction with the drawings.

### SUMMARY OF THE INVENTION

The general purpose of the present invention, which will be described subsequently in greater detail, is to provide a new method of electronic notarization by a notary public that is not anticipated, rendered obvious, suggested, or even implied by any of the prior art, either alone or in any-combination thereof.

Described briefly, the method and system of the present invention function to provide and perform signature verification using a live notary public to authenticate and facilitate transactions in e-commerce that traditionally require the security and enforceability of a notary seal and jurat. The invention is particularly suited to electronic commerce transactions, such a mortgage, banking, financing and identity verification, whereby a traditional notarization by a live notary public is a prerequisite to closing the deal. Thus, the present invention has devised a system and method to allow such transactions to be notarized by a licensed notary public, albeit in a format that is compatible to electronic documents.

A customer or client wishing signature verification in the form of notarization for an electronic document contacts a notary public with the means to operate the present invention as contemplated herein. The customer may visit the notary public, or alternatively, the notary public may travel to a location designated by the customer. Commercial account customers, such as mortgage brokers, banks, and the like, may have access to the inventive device on their premises, assuming such commercial account customers employ an individual who is also a licensed notary public.

As a priori, the notary public must register with a database maintained by the inventive device. The purpose of registration is to ensure the authenticity of the notary public and to allow the notary public access to the inventive device. Registration ensures that the notary is indeed a bona fide notary public licensed by its respective state. Registration is also necessary for the notary public to operate the inventive device. Once registered with the database, each time the notary public attempts to effect a notarization, confirmation via the database as to the notary public's identity, occurs, prior to the inventive device authorizing a valid notarization.

Upon registering with the inventive database's device, a notary public will be issued a registered electronic notary seal, as described more fully herein and below. The electronic notary seal is a stand-alone hardware device that is to remain in the sole possession of the notary public. The electronic notary seal will only be able to execute a valid notarization when used by the notary public to whom the seal is issued. The electronic notary seal will be able to effect a notary seal in various formats.

In the preferred embodiment, the notary seal is a graphical representation of a traditional notary seal, accompanied b a graphical representation of the notary jurat. In another embodiment, the notary seal is an encrypted barcode accompanied by a representation of the jurat in the form of a barcode. Irrespective of the form of the notary seal or the jurat, the notarization contains all information required by law to effect the notarization, including, but not limited to, the party's name, identification, including biometric information, the document a type and name, and the place, date and time of notarization. Irrespective of the form of notarization selected, the present device records the transaction in an electronic notary journal. The electronic notary journal contains all of the information required by law and remains in the sole possession of the notary public.

As stated, a customer or client in need of an electronic notarization for an electronic document, employs the services of a notary public with access to the inventive device. The customer or client may bring the notary public the electronic document or set of electronic documents in a portable medium, such as a floppy disc or a CD ROM to the notary public. Alternatively, the notary public ma download the appropriate electronic document or set of electronic documents (collectively referred to as the “electronic document”) from an electronic document repository maintained by the inventive device.

Upon finalization of an electronic document, the electronic document is encrypted and assigned a corresponding temporary signing password. Upon assigning a temporary signing password, no information may be added, deleted or modified to the electronic document prior to signature. Each signatory is given the corresponding temporary signing password. The signatory reveals the electronic document corresponding temporary signing password to the notary public, who either uploads or downloads the electronic document to a local computer system. The local computer system is equipped with a desktop manager that is a software application specifically designed to operate in conjunction with the notary seal remote hardware device. That is, the hardware device will only operate recognition by the desktop manager as a valid authorized notary seal device in the possession of its authorized notary public.

After download or upload of the electronic document by the notary public, the desktop manager highlights or otherwise indicates each and every place where a signature or the initials of the signatory is required in the electronic document. The signatory inputs a manual, hand-written signature to the electronic document, using an electronic signature capture input device. The notary public inputs a manual, hand-written signature to the electronic document, using the electronic signature capture input device. The notary public next affixes an electronic notary seal to the electronic document where indicated by the desktop manager.

The notary public affixes the notary seal by way of the electronic notary seal hardware device. After affixing the notary public's signature and seal, the desktop manager automatically executes the electronic notary journal in conjunction with the notary seal hardware device. The electronic notary journal creates an independent electronic record of the notarization that remains in the sole possession of the notary public. The electronic notary journal consists of all of the information required by law to legally enforce the notarization of the transaction. After recording the transaction in the notary journal, the signed, notarized electronic document is encrypted and a time/date stamp is applied. Any changes made to the electronic document after this point in time invalidate the electronic document.

It has been discovered, according to the present invention, that if transactions requiring traditional notarization can be electronically notarized using an in-person method of notarization, such type of transactions can be conducted on-line thereby saving substantial amounts of time and money.

It has been discovered, according to the present invention, that if transactions requiring traditional notarization can be electronically notarized using a paperless transaction platform, such type of transactions can be conducted on-line thereby saving substantial amounts of time and money.

It has been discovered, according to the present invention, that if the access and transport of electronic documents and notary public services can be accomplished online, that the executed electronic documents can be rapidly verified and validated without waiting for paper documents to be physically shipped to a remote location or without having the parties travel to a remote location, thereby saving substantial amounts of time and money.

It has been discovered, according to the present invention, that if notary services using a paperless transaction platform can be accomplished online, then sensitive agreements, or high-value transactions and the like, which traditionally and legally require a notary seal, do not sit on hold and can be executed more rapidly and efficiently.

It has additionally been discovered, according to the present invention, that if notary services paperless transaction platform can be accomplished online, it reduces courier costs and possible delay by the couriers who transport the documents to remote locations to be signed.

It is therefore an object of the present invention to provide a method for performing signature verification using a notary public, with the capability of rapidly signing and notarizing electronic documents at remote locations without physically transporting the documents to the remote location to be signed by signatories and notarized by a participating notary public at the remote location.

It is therefore an object of the present invention to provide a method for performing signature verification using paperless transaction platform, with the capability of rapidly signing and notarizing electronic documents at remote locations without physically transporting the documents to the remote location to be signed by signatories and notarized by a participating notary public at the remote location.

It is a further object of the present invention to provide a method and system for providing and performing electronic notary services using a paperless document platform, where notarizations can take place at the notary's place of business having internet access or wherever there is internet access.

It is a further object of the present invention to utilize the most trusted and secure form of identity and signature verification, a licensed notary public, to execute binding legal electronic documents to ensure long-term legal enforceability.

It is a further object of the present invention to enable high value or sensitive electronic document transactions requiring an in-person notarization to be conducted on-line using a paperless electronic document platform.

It is a further object of the present invention to integrate all of the parties to high value or sensitive transactions on-line by providing a standardized set of electronic documents that are accessible on-line and interchangeable among the parties on-line, including the notary public.

There has thus been outlined, rather broadly, the more important features of the invention in order that the detailed description thereof may be better understood, and in order that the present contribution to the art may be better appreciated. There are additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCIRIPTION OF THE DRAWINGS

FIG. 1 is a diagram of a host system in which the present invention may be advantageously applied.

FIG. 2 is a diagram of a host system in which the present invention may be advantageously applied.

FIGS. 3A-3B is a diagram of a host system in which the present invention may be advantageously applied.

FIGS. 4A-4B is a diagram of a host system in which the present invention may be advantageously applied.

FIG. 5 is a diagram of a host system in which the present invention may be advantageously applied.

FIG. 6 is a diagram of a host system in which the present invention may be advantageously applied.

FIGS. 7A-7B is a diagram of a host system in which the present invention may be advantageously applied.

FIG. 9 is a diagram of a host system in which the present invention may be advantageously applied.

FIG. 9 is a diagram of a host system in which the present invention may be advantageously applied.

### DETAILED DESCRIPTION OF THE PREFERRED EMBODIMENT

I. Description of Present Invention

Although specific embodiments of the present invention will now be described in detail and with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

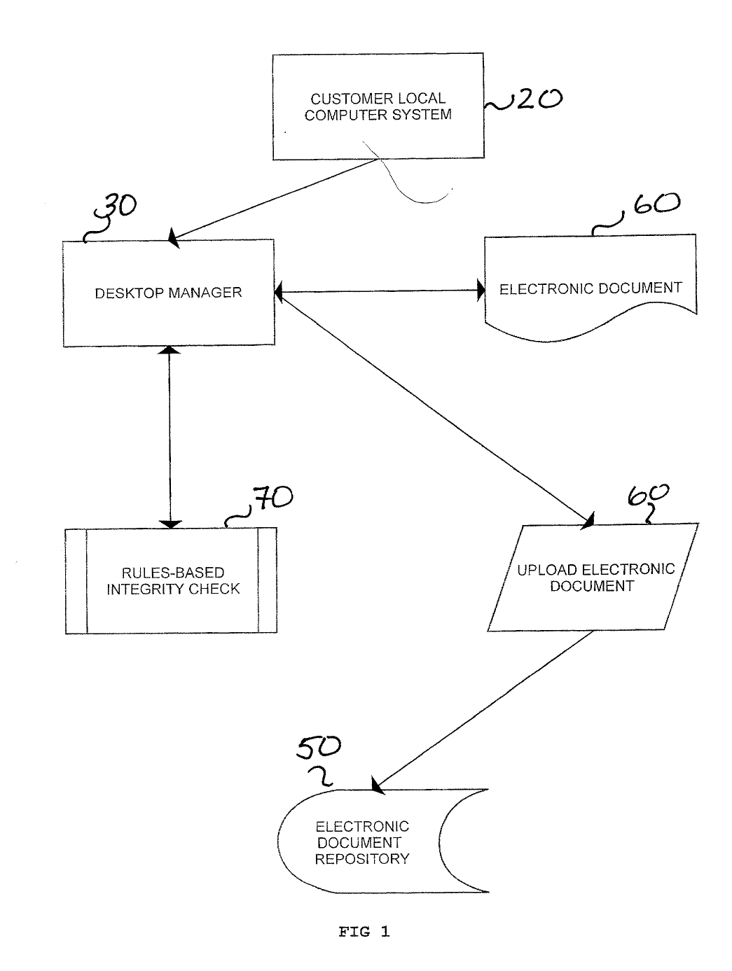

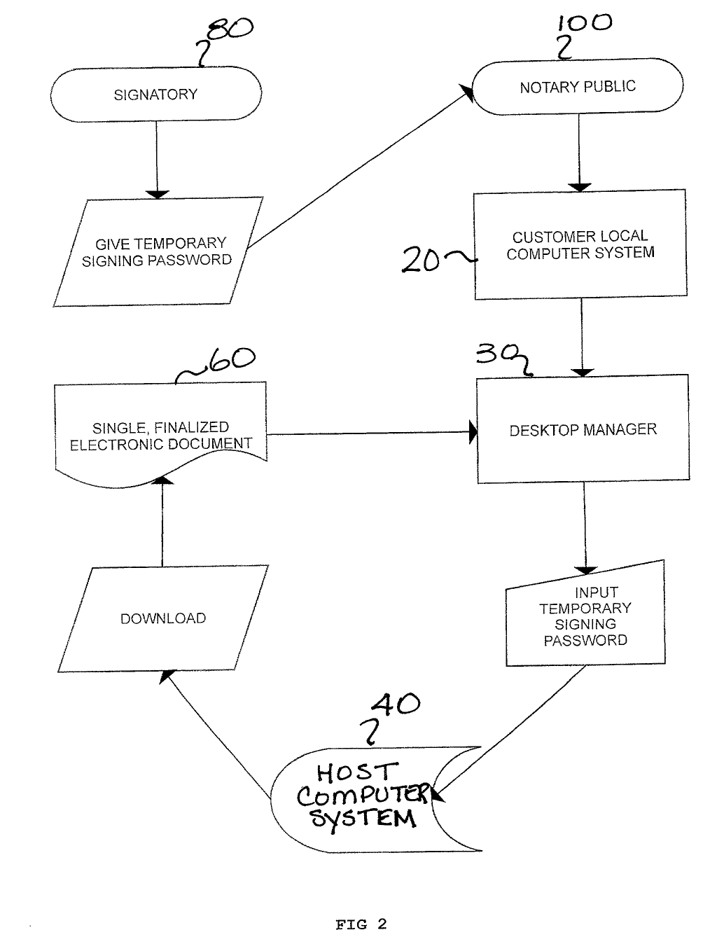

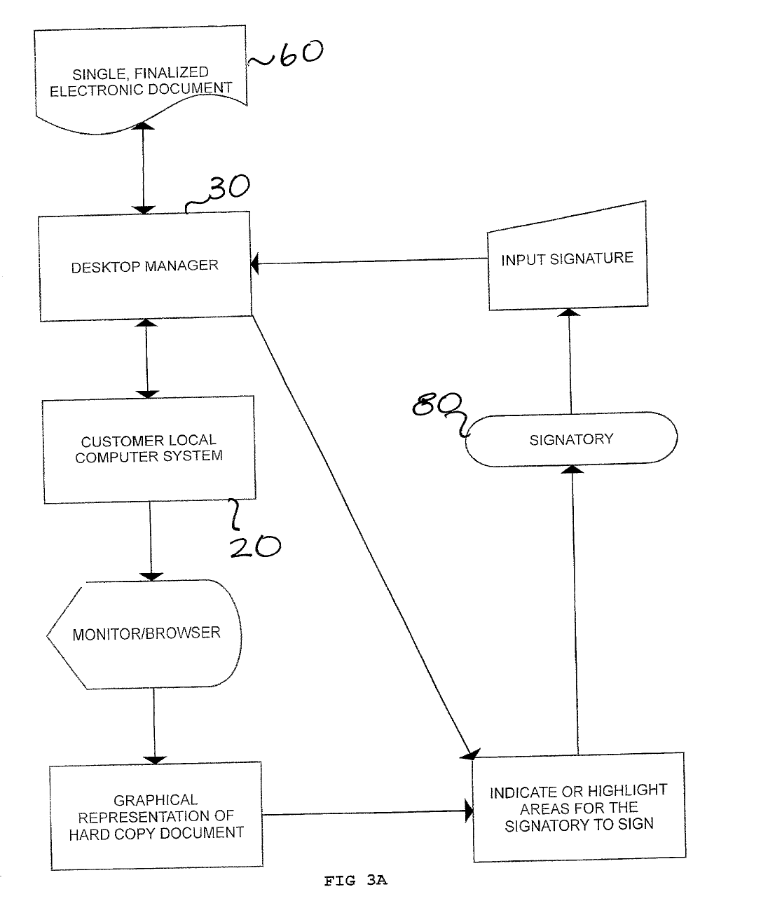

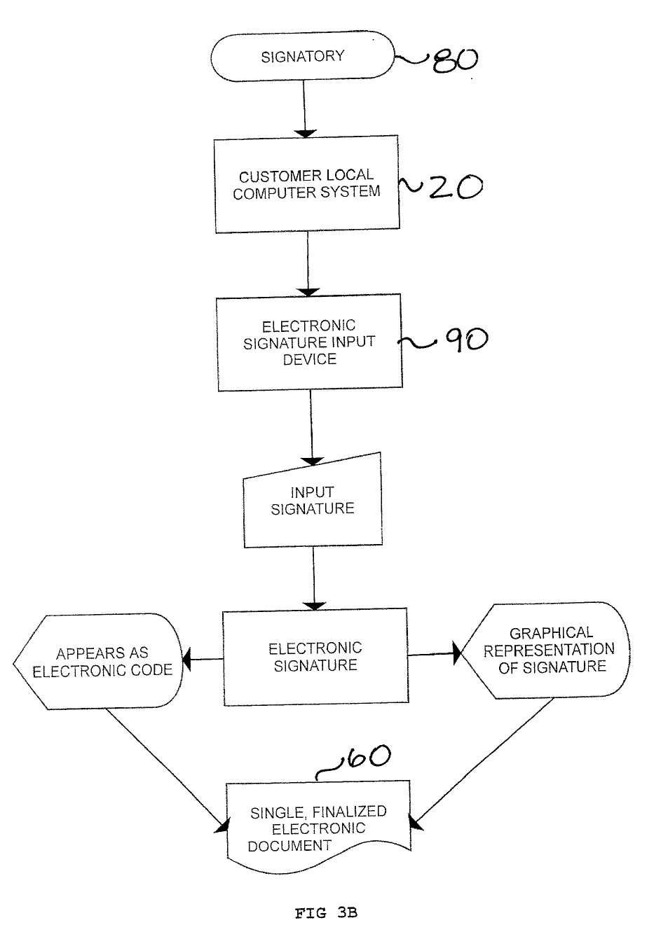

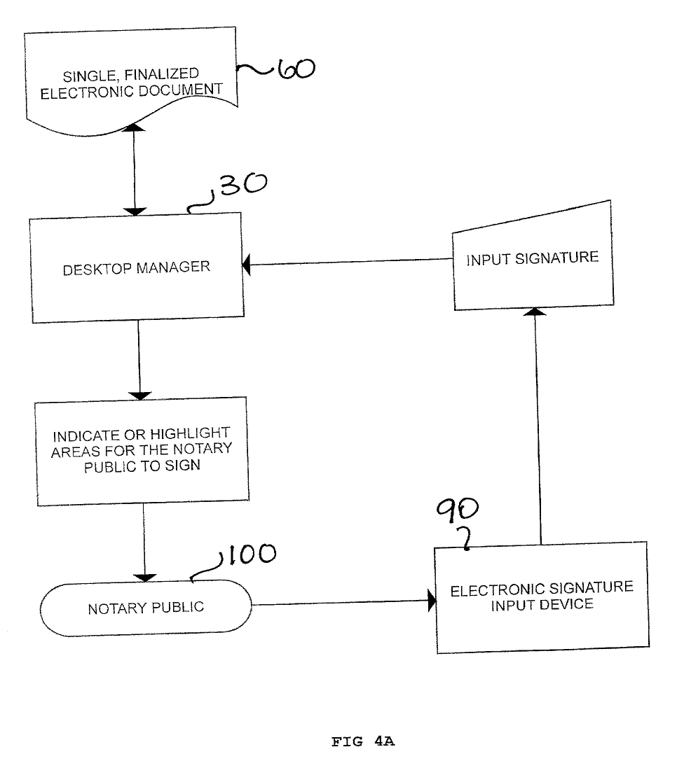

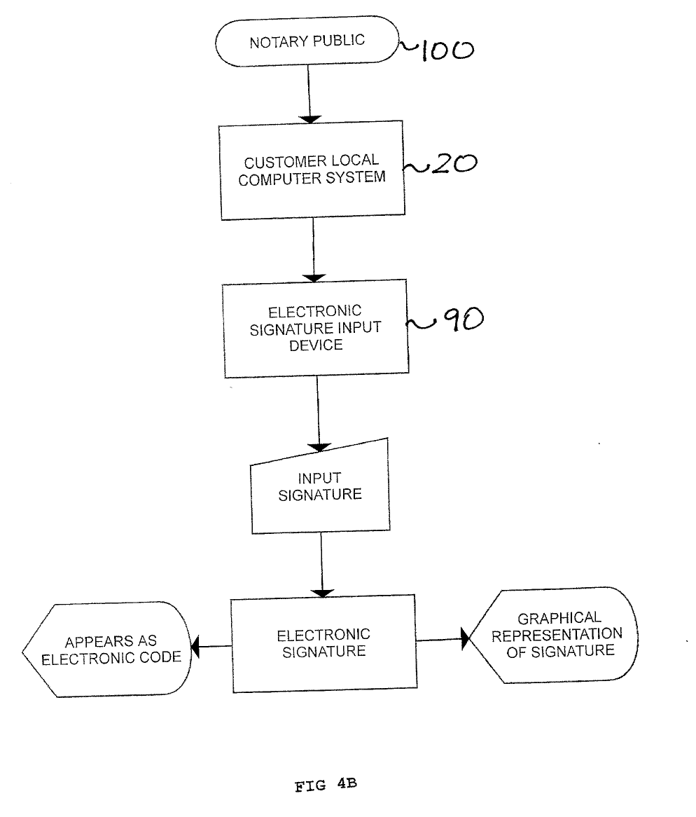

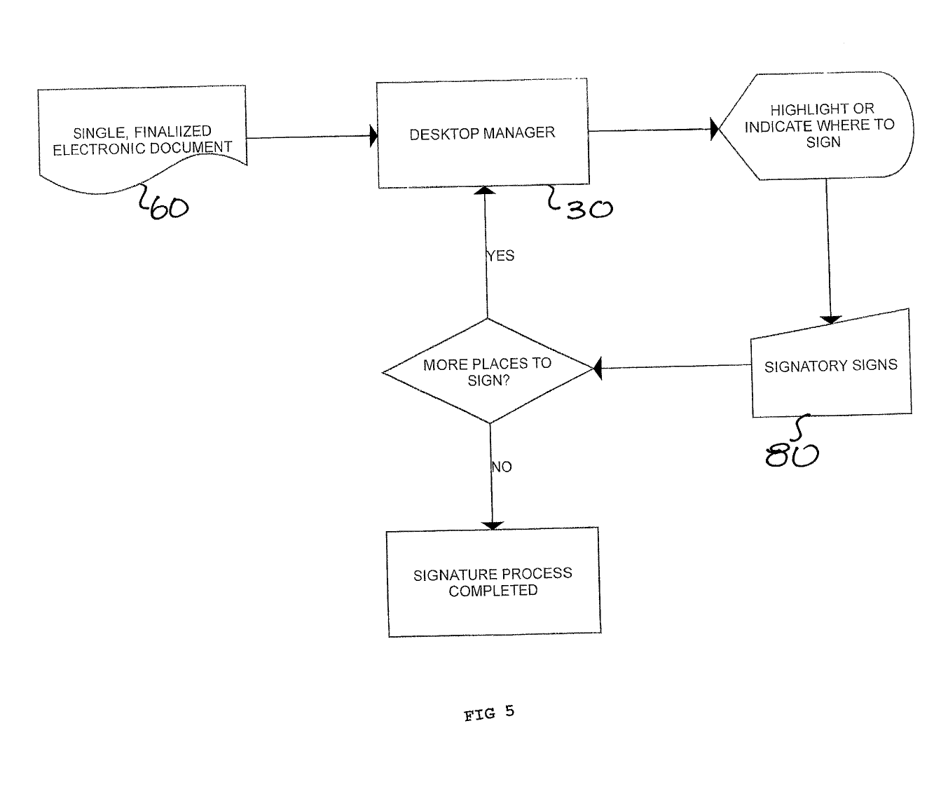

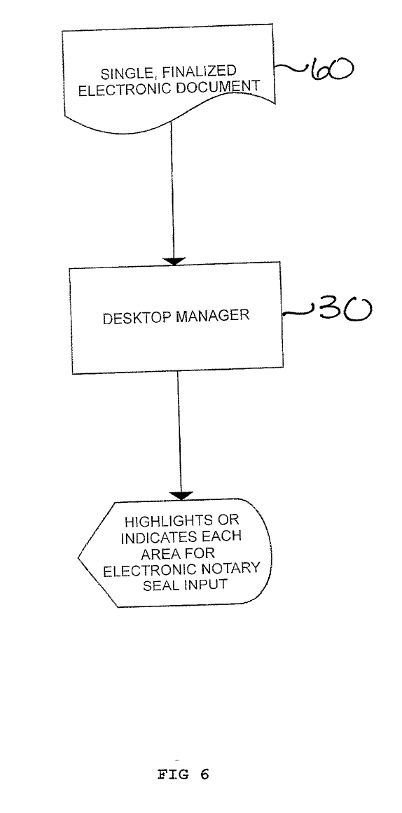

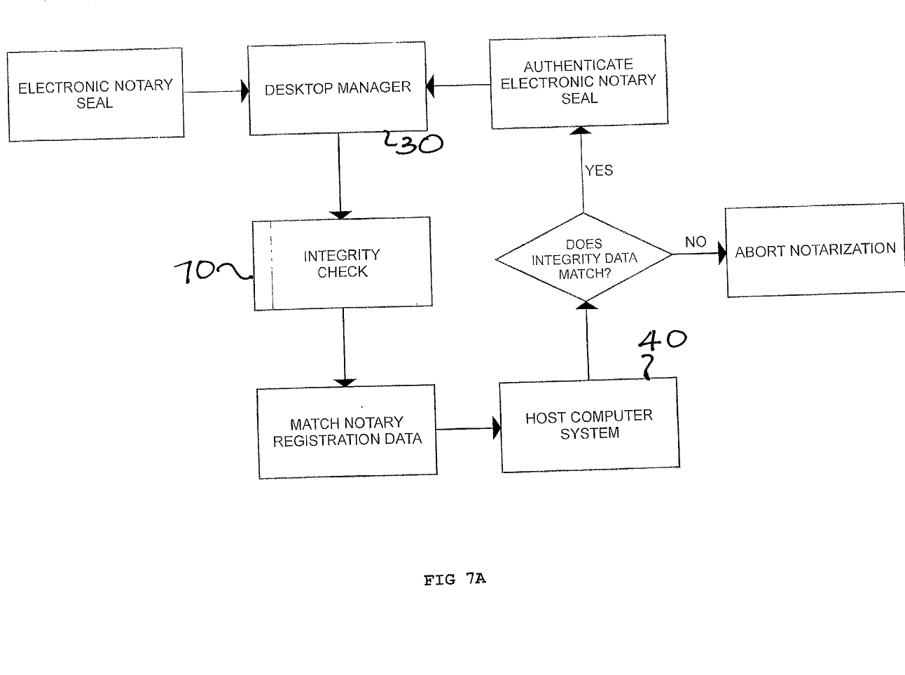

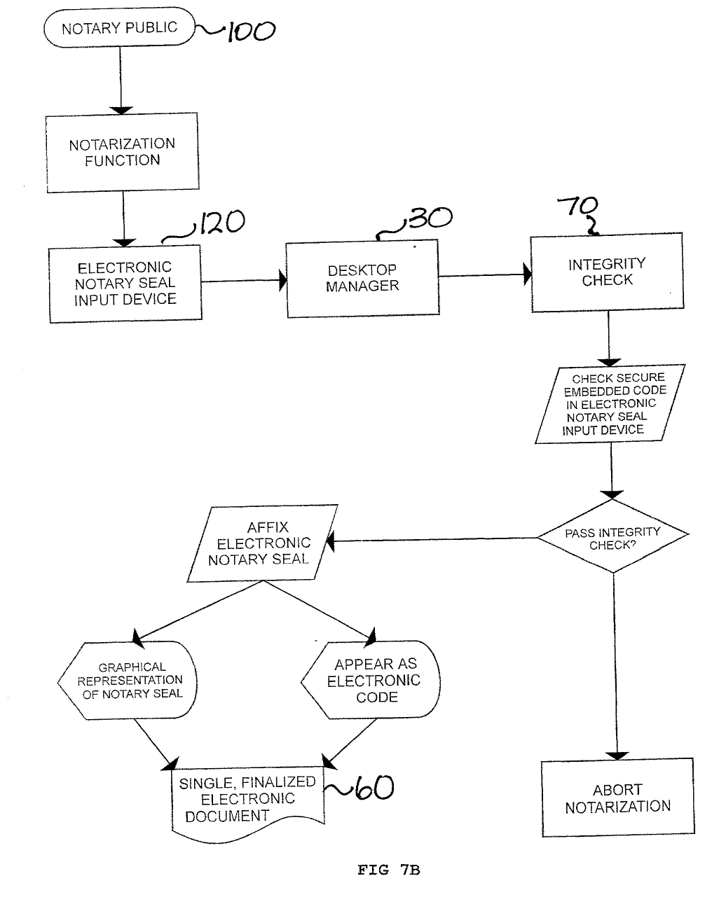

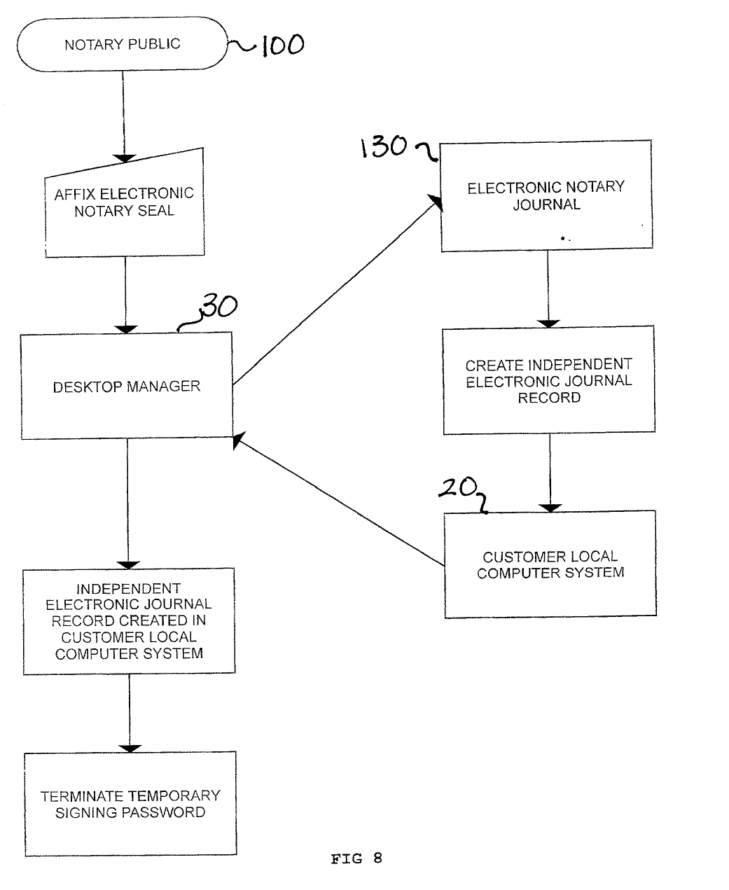

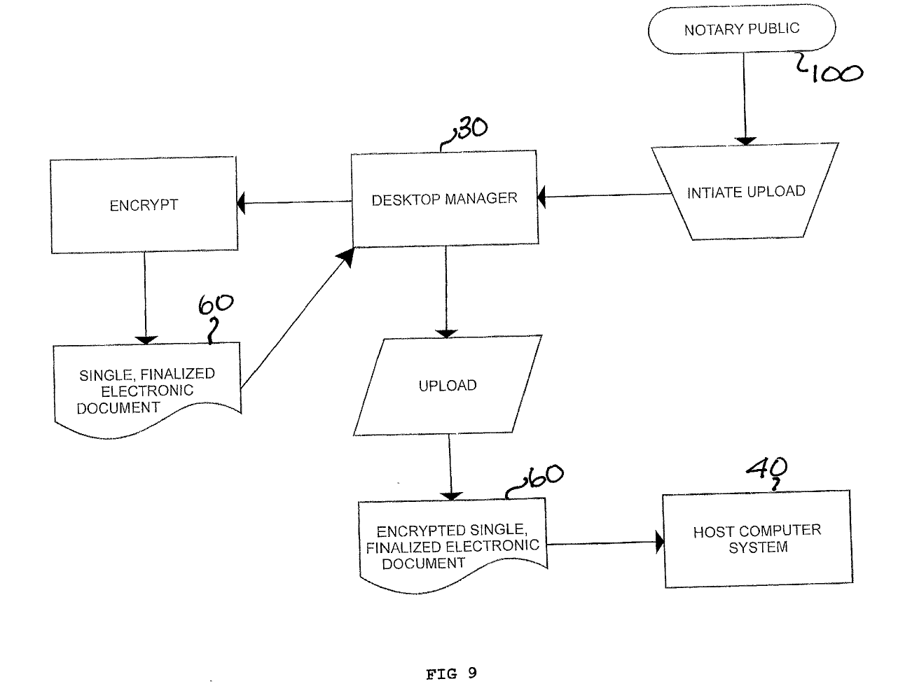

With reference to FIG. 1, the method and system of the present invention comprises a customer 5, the internet or other TCP/IP based networks 10, a customer local computer system 20, a desktop manager 30, a host computer system 40, an electronic document repository 50, an electronic document 60, a rules-based integrity check 70, a signatory 80, an electronic signature input device 90, a notary public 100, notarization processes and methods 110, an electronic notary seal 115, an electronic notary seal input device 120, and an electronic notary journal device 130.

The desktop manager 30 runs on the browser of the customer local computer system 20 of the notary public 100 and provides the interface that allows the notary public 100 to operate the present invention by the processes and methods described herein. The desktop manager 30, is the interface that allows the notary public 100 to establish a registration account 31 with the host computer system 40, to download and upload an electronic document 60 from the electronic document repository 50, to input an electronic signature 80 onto the electronic document 60 using the electronic signature input device 90, to input an electronic seal 115 using the electronic notary seal input device 90, to execute notarization processes and methods 110, to execute the electronic notary journal 130 and to authenticate the notary public seal 115 as being authentic.

The electronic signature input device 90 is a device that is remote to the customer local computer system 20 or is a function embedded within the customer local computer system 20. The electronic signature input device 90 captures the manual, hand-written signatures 80 of the signatory and the notary public 100. The desktop manager 30 indicates on the browser of the customer local computer system 20 where the electronic signature 80 of the signatory and the notary public 100 are to be input into the electronic document 60. The desktop manager 30 affixes the captured electronic signature 80 of the signatory and the notary public 100 to the electronic document 60. The electronic notary seal input device 90 is a device that is remote to the customer local computer system 20 that operates in conjunction with a function embedded within the desktop manager 30. The electronic notary seal input device 90 executes an electronic notary seal 115 or an electronic notary jurat (collectively referred to as the “notary seal”) of the notary public 100 to the electronic document 60. The desktop manager 30 indicates on the browser of the customer local computer system 20 where the electronic notary seal 115 is to be input into the electronic document 60, and the desktop manager 30 affixes the captured electronic notary seal 115 to the electronic document 60. The electronic notary journal 130 is a function of the desktop manager 30. The electronic notary journal 130 executes upon a notary 26 public's 100 signature 80 and seal 115 being affixed to the electronic document 60. The electronic notary journal 130 contains all of the verification information of the transaction required by law. The electronic notary journal 130 is a record that remains in the sole possession of the notary public 100 to whom it belongs.

II. Operation of the Present Invention

The method and system of the present invention function to provide and perform signature verification services by a live notary public 100 via the internet or other TCP/IP based network 10 using a paperless document platform which consists of a customer local computer system 20, a desktop manager 30, a host computer system 40, electronic document repository 50, an electronic document 60, a rules-based integrity check 70, a signatory 80, an electronic signature input device 90, a notary public 100, notarization processes and methods 110, an electronic notary seal input device 120, and an electronic notary journal device 130.

With reference to FIG. 1, a customer 5 with internet or TCP/IP connectivity 10 may either a website, a local access network (LAN) or a wide access network (WAN) using a client-server infrastructure, to provide the point of access to the present invention. In the preferred embodiment of the present invention, the request for signature verification using a paperless document platform is initiated by the customer 5 accessing a website on the world-wide-web using the customer local computer system 20. The website provides the customer 5 with information about the services available and information in the form of a tutorial on how to register with, and use the present invention. Alternatively, the invention may be configured for use an a restricted LAN or a restricted WAN.

Any party to an electronic transaction that requires signature verification, the “customer” 5, may initiate a notarization request to the host computer system 40, using a customer local computer system 20. The customer 5 may be, but need not be, the signatory 130, whose signature is to be notarized by a notary public 140, or a commercial customer client. For example, a loan officer, an escrow officer, or a regulatory agency may be the customer 5 that requests notarization of an electronic document 80 that eventually will be signed by a different signatory 130, for example, a loan applicant.

In the preferred embodiment, the customer initiates a request for notarization by the present invention using a local computer system 20 from a remote location (i.e. the home, office, or a laptop), that establishes internet or TCP/IP connectivity 10 with the host computer system 40.

The host computer system 40 maintains a website that offers information about the inventive device, including how to obtain an electronic notarization and a list of authorized notary publics 100 with the means to use the inventive device. Should the customer 5 so elect, the customer 5 may request the services of an electronic notarization on-line A with an authorized notary public 100. The website shall prompt the customer 5 to input the list of services needed in the form of a pull-down menu, from which the customer 5 shall select the required services. With respect to requested services, in addition to the request for notarization 110, the customer 5 may chose to download an electronic document 60 for notarization 110, or the customer 5 may choose to supply its own electronic document 60 for notarization 110. Should the customer 5 elect to use its own electronic document 60 for notarization 110, the customer 5 will be responsible for bringing the electronic document 60 to the notary public 100 in the form of a floppy diskette or a CD ROM, or some other portable medium capable of storing electronic data. Alternatively, from the list of services available on the website, the customer 5 may chose to upload its electronic document 60 into a database maintained by the host computer system 40, for future download retrieval at another time and location by a notary public 100.

Alternatively, from the list of services available via the website, the customer 5 may elect to download an electronic document 60, or a set of electronic documents 60, that need to be notarized 110, from an electronic document repository maintained by the host computer system 40. The electronic document repository 50 consists of various electronic documents 60 that are specific to certain transactions and certain sectors or industries. For example, the electronic document repository 50 may consist of electronic documents 60 for the financial and banking sector, the real estate sector, or government/regulatory agencies and the like. The electronic documents 60 may be listed by type; i.e. deeds of trust, or by category; i.e. banking documents. A customer 5 may opt to post a “restricted access group” within the electronic document repository 50. A restricted access group consists of confidential electronic documents 60 that are proprietary to a specific customer 5 and may only be accessed or utilized by that particular customer 5 or users authorized by the customer 5.

In any category, the electronic document 60 may be represented singularly, or as a grouped set of electronic documents 60 (collectively referred to as the “electronic document” 60). The electronic document repository 50 may be used in conjunction with a request for notarization o independently. Should the customer 5 elect to download a electronic document 60, the customer shall be responsible for inputting the required information to complete the electronic document 60. In the preferred embodiment, the electronic document 80 appears as a graphical representation on the browser of the local computer system 20, and areas in the electronic document 80 requiring information to be input shall be highlighted or otherwise indicated by the desktop manager 30. Alternatively, the electronic document 60 appears as a graphical representation on the browser of the local computer system 20 alongside fields, information being input into these fields that appear in the graphical representation of the electronic document 80. Per the methodology above, the customer 5 may elect to save the downloaded electronic document 60 on a in the form of a floppy diskette or a CD ROM, or some other portable medium capable of storing electronic data. Alternatively, from the list of services available an the website, the customer 5 may chose to upload the downloaded electronic document 60 into a database maintained by the host computer system 40, for future download retrieval at another time and location by a notary public 100.

Irrespective of whether the customer 5 supplies its own electronic document 60, or uses an electronic document 60 from the electronic document repository 50, the customer 5 selects a request for notarization 110 services by a notary public 100. From a pull-down menu the customer selects from the following services: (a) to make an appointment to travel to a notary public 100 with access to the inventive device; (b) to make an appointment to have a traveling notary public 100 with means to the inventive device to come to the customer 5; (c) or for a list and locations of notary publics 100 where no appointment is needed. Upon selection of either “a” or “b” the host computer system 40, via the website, shall prompt the customer 5 for the proximate location and date at which notarization 110 services are needed. Upon customer input of the required information, the host computer system 40 shall provide and confirm the time, location and date for the notarization 110, in a real-time exchange with the customer 5 via the website. Additionally, the host computer system 40 shall send the customer 5 a confirmation of the time, and date, and location of the notarization via electronic mail.

The request for notarization 110 services is supplied to the customer 5 via the host computer system 40 cross-checking its database of registered notary publics 100. The host computer system 40 selects a notary public location from a database of registered notary publics 100 and supplies the customer 5 with the most convenient location match. Upon confirming a notarization 110 service to a customer 5, the notary public 100, is informed via electronic message of the impending notarization 110 appointment, including the nature of the request for services. Notary publics 100 that are unavailable for any given period of time are required to notify the host computer system 40, via electronic mail or inputting information into a restricted database that tracks the scheduling of appointments, to ensure that there are no scheduling conflicts.

As the foregoing would indicate, registration by the notary public 100 with the inventive device is a priori for two reasons: for the effective scheduling of notarization 110 appointments via the website and otherwise, as put forth above, and to allow the notary public 100 access to, and the authority to use, the inventive device. With reference to FIG. 2, registration with the host computer system 40 is a prerequisite to using the present invention by the notary public 100. The notary public 100 establishes a registration account 31 with the host computer system 40.

Registration of a notary public 100 by the present invention requires an in-person verification of the notary public's identity, license, and related credentials. Registration entails the notary public 100 providing verification information to register with the present invention as a duly licensed notary public 100. The notary public registration account 31 is recorded in the host computer system 40, and is a permanent record that is subject to verification by the rules-based integrity check each and every time prior to the desktop manager 30 executing the notarization processes and methods 110, as described more fully below. After the notary public 100, successfully establishes a registration account 31, with the host computer system 40, the inventive device issues the notary public 100 a notary seal input device 120. The notary seal input device 120 is specially configured for the notary public 100, and is to remain in the sole possession of the notary public 100. The notary seal input device 120 is the means by which the notary public 100 shall affix a legally binding notary seal and jurat to are electronic document 60, the system and method of which are fully put forth below.

With reference once again to FIG. 1, upon the customer 5 receiving confirmation of the time, date and location of the notarization 110 appointment, the customer 5 travels to the notary public 100 as designated by the host computer server 40. Alternatively, a notary public 100 may travel to a location designated by the customer 5. The present inventive device may be used remotely so long as the notary public 100 has a portable PC device and access to the Anti 18 internet or other means of TCP/IP connectivity. In either situation, the process of notarization 100 according to the present invention is the same.

In the preferred embodiment, the customer 5 provides the notary public 100 with a floppy diskette, CD ROM or some other portable medium capable of storing electronic data, on which the electronic document 60 to be notarized 110 is stored. The notary public 100 executes the desktop manager on the browser of the notary public's 100 local computer system 20. The desktop manager 30 opens the electronic document 60 supplied by the customer 5 on the portable medium; the electronic document 60 is displayed on the browser of the notary public's 100 local computer system 20 browser. Upon the desktop manager 30, opening the electronic document 60, from the portable medium supplied by the customer 5, the desktop manager 30 locks and encrypts the contents of the electronic document 60, so that the contents of the electronic document 60 may not be changed, modified, or altered in any form. Said encryption is permanent, at this point in time, the contents of the electronic document 60 are fixed.

The desktop manager 30 highlights or otherwise indicates each and every place where an electronic signature or initials is required in the electronic document 60. Indication will typically appear as an icon such as an arrow or some other pointing device that physically demonstrates on the browser of the customer local computer system 20 which part of the electronic document 60 the signatory 80 is initializing or signing. To ensure the signor's intent, each place indicated by the desktop manager 30 requiring a signature or initials must be physically input using the electronic signature input device 90. That is, the desktop manager 30 will not replicate signatures if multiple signatures are required in the electronic document 60, but mandate that the signatory 80 sign each place in the electronic document 60 where indicated by the desktop manager 30.

After reviewing the electronic document 60 on the browser of the notary public's 100 local computer system 20, in the presence of the notary public 100, the signatory 80 affixes an actual hand-written signature to the electronic document 60 using the electronic signature input device 90. The signatory's 80 actual hand-written signature is captured and affixed to the electronic document 60 by way of the electronic signature input device 90. The electronic signature input device 90 may be a part of the customer local computer system 20 or a device external to it, but nonetheless connected to the local computer system 20.

In the preferred embodiment of the present invention, the electronic signature input device 90 utilizes the traditional pen and ink method of physically signing one's own signature, albeit using an electronic stylus. The desktop manager 30 electronically affixes the electronic signature 80 to the electronic document 60 as a graphical representation, such as “John Doe”, or “J. D.”. Per the method above, the desktop manager 30, will input the respective signature 80 in the corresponding part of the electronic document 60. No one signature 80 will be duplicated, rather each signature 80 will appear as manually created by the signatory 80, using the signature input device 90.

Alternatively, the electronic signature 80 captured by the electronic signature input device 90 may be encrypted as a password or code that is unique to the signatory 90 and linked with the corresponding electronic document 80. Per the method above, said signature 80 will be input using the signature input device 90, but shall not appear as a graphical representation, rather as a barcode or combination of alpha numeric. Per the method above, the desktop manager 30, will input the respective barcode or password signature 80 in the corresponding part of the electronic document 60. No one signature 80 will be duplicated, rather each signature 80 will appear as manually created by the signatory 80, using the signature input device 90, even if in effect the multiple signatures 680 have in effect the same appearance, being a barcode or password.

Upon the signatory 80 affixing all of the require signatures to the electronic document 60, the electronic document 60 is ready for notarization. The desktop manager 30 consists of a separate notarization function that allows the notary public 100 to electronically affix a notary seal and jurat to the electronic document 60.

After witnessing the signatory 80 physically sign the electronic document 60, the notary public 100 affixes a signature 80 to the electronic document 60 where indicated by the desktop manager 30, using the electronic signature input device 90. In the preferred embodiment, the electronic signature input device 90 utilizes the traditional pen and ink method of physically signing one's own signature, albeit using an electronic stylus. The desktop manager 30 electronically affixes the notary public's 100 electronic signature 80 to the electronic document 60 as a graphical representation, such as “Notary Public ”, or “N. P.”. Per the method above, the desktop manager 30, will input the notary public's 100 respective signature in the corresponding part of the electronic document 60 reserved for notarization.

Alternatively, the notary public 100 electronic signature 80 captured by the electronic signature input device 90 may be encrypted as a password or code that is unique to the notary public 100 and linked with the corresponding electronic document 80. Per the method above, said notary public 100 signature 80 will be input using the signature input device 90, but shall not appear as a graphical representation, rather as a barcode or combination of alpha numeric. Per the method above, the desktop manager 30, will input the respective barcode or password signature 80 in the corresponding part of the electronic document 60 reserved for notarization.

After affixing a notary public 100 signature 80 to the electronic document 60, the notary public 100 affixes an electronic notary seal 115 to the electronic document 60. The notary public 100 electronically affixes the electronic seal 115 to the electronic document 60 using the electronic notary seal input device 90. The remote electronic notary seal input device 90 is pre-configured uniquely for each notary public 100 and is registered to the notary public 100. Each electronic notary seal input device 90 contains a particular serial number assigned and registered to the notary public 100 by the host computer system 40. The desktop manager 30 verifies that the serial number associated with the remote electronic notary seal input device 90 is an authorized, registered device. The notarization function of the desktop manager 30 will run with only upon verification of registration. The notary public 100 may choose to add extra coding to the remote electronic notary seal input device 90 in the form of a password or code for additional security. The portable hardware device allows the notary public 100 to have sole control and possession of the electronic notary seal input device 90, thereby securing compliance with prevailing governmental regulations. The portable hardware device further allows the notary public 100 to electronically notarize electronic documents 60 wherever the notary public 100 customer local computer system 20 has access to the internet or TCP/IP connectivity 10, including a laptop. The portable hardware device is easily transportable and can be used at diverse locations to another without a cumbersome uninstall/install process.

The electronic notary seal input device 90 is a device that is independent of the desktop manager 30 but nonetheless operates only in conjunction with the desktop manager's 30 notarization function. Likewise, the desktop manager's 30 notarization function only operates when activated by the electronic notary seal input device 90. The electronic notary seal input device 90 may be a function embedded in the customer local computer system 20 or a portable device that attaches to the customer local computer system 20. The electronic notary seal function 115 will only operate in conjunction with the notary seal input device 90 verifying the credentials of the notary public 100 in the host computer system 40 registration database. As stated, verification information consists of that information required by law to license and register with a respective state as a notary public.

In the preferred embodiment pf the present invention, the electronic notary seal input device 90 is a remote hardware device that remains in the sole possession of the notary public 100. The notarization function of the desktop manager 30 will only run when the electronic notary seal input device 90 is attached to the notary public 100 customer local computer system 20. The remote electronic notary seal input device 90 is a hardware-based security portable device that attaches to the serial or parallel printer port of the notary public 100 customer local computer system 20, including a portable laptop of the traveling notary public 100. The remote electronic notary seal input device 90 utilizes a hardware key that uses codes and passwords embedded inside the key to control access to the desktop manager's 30 notarization function. While activated, the electronic notary seal input device 90 receives encoded data from the desktop manager 30 an decodes it in a way that cannot be imitated. The decode data that is returned from the remote electronic notary seal input device 90 is deployed in the desktop manager 30 so that it affects the mode in which the desktop manager 30 executes the notarization function 110. The remote electronic notary seal input device 90 is programmed to execute a notarization 110 upon a verified match with the desktop manager 30. After decoding, a verified match executes the notarization function of the desktop manage 30 that in turn activates the execution of the electronic notary seal 115 which is embedded in the remote electronic notary seal input device 90.

The desktop manager 30 indicates by way of an arrow or a icon that appears on the browser of the notary public's 100 customer local computer system 20 where the electronic seal 115 shall be input and appear on the electronic document 60. In the preferred embodiment of the present invention, the electronic notary seal 115 appears as a graphical representation of a traditional notary seal on the electronic document 60, such as depicted in with reference to FIG. ______. The graphical representation may include an encrypted code that is affixed to the electronic document 60 that contains the date and time the notary public's 100 electronic seal 115 was affixed and the verification information of the notary public 100 provided in the notary public's registration account 31.

Alternatively, the remote electronic notary seal input e14 device 90 may input an electronic notary seal 115 in the form of an encrypted barcode that appears on the electronic document 60. The notary barcode seal 115 of the remote electronic notary seal input device 90 is verified by the desktop manager 30 that utilizes a secure server database specifically configured to authenticate the notary barcode seal. The notarization function 110 of the desktop manager 30 will only execute upon a verification from the secure server of a positive code match with the notary barcode seal embedded in the remote electronic notary seal device 90. The inventive device uses a standard barcode reader employing light to convert the notary barcode into an electrical signal. The barcode reader measures the relative widths of the bars and spaces of the notary barcode, translates the code into regular characters, and transports the translation to the host computer system 40.

Each notary barcode seal 115 begins with a special start character and ends with a special stop character. The notary barcode seal may include a checksum character just before the stop character. The checksum is calculated using the characters in the notary barcode seal before the notary barcode seal may be affixed to the electronic document 60. The barcode reader performs the same calculation and compares its answer to the checksum it read at the end of the notary barcode seal. If the two calculations do not match, the barcode reader shall invalidate the notary barcode seal. The barcode of the present invention is not a standard bar code scheme that is typically obtained from an independent party, rather the barcode is a proprietary-based, secure software application embedded in the remote electronic notary seal input device 90. The data in a bar code denotes a reference number that the secure server utilizes to look up the associated computer record that contains descriptive verification data of the notary public 100 to whom the corresponding barcode seal is registered to. The barcode may further contain the date and time the notary public's 100 seal was affixed and the verification information for the notary public 100.

Upon affixing the notary public 100 signature 80 and seal 115, the desktop manager 30 automatically executes the electronic notary journal 130. The electronic notary journal 130 creates an independent electronic record of the notarization 110 transaction. The electronic notary journal contains all of the information required by law to legally enforce the notarization 110 of the electronic document 60. Upon recording the notarization transaction in the electronic notary journal 130, the desktop manager 30 encrypts the signed, notarized, electronic document 60 and applies a time and date stamp. Any changes made to the electronic document 60 after this point in time invalidate the notary public's 100 seal 115.

Upon successful notarization 110, the customer 5 may request that the signed, notarized, electronic document 60 be saved to a portable medium, such as a floppy diskette, a CD ROM, or some other portable medium capable of storing electronic data. Alternatively, the customer may request that the signed, notarized, electronic document 60 be uploaded by the notary public 100 onto the host computer system 40 for retrieval by the customer 5 at a future time and location. Alternatively, a customer 5 may have the notary public 100 print a hard copy of the electronic document 60, if so desired. The host computer system 40 archives the signed, notarized, electronic document 60 for future use and retrieval by approved parties.

Definitions

Given the possible breadth of the present invention's potential, it is to be understood that the following terms as used anywhere in the application herein shall be construed to have the following meanings:

Electronic Notary Seal

A notary seal shall be construed to encompass the following meanings: an electronic graphical representation of a notary seal, an electronic graphical representation of a notary jurat, a barcode representation of a notary seal, a barcode representation of a notary jurat, an electronic representation of a notary seal, or an electronic representation of a notary jurat.

Electronic Document: The term “electronic document” shall be construed to mean any data that is constructed and compiled by use of the present invention; including but not limited to, digital or electronic documents in various mediums, whether tangible or not (i.e. source code, compact disc, floppy diskette, etc.); documents encompassing an array of transactions and documents comprised of tracking, managing and storing information created by use of the invention.

Electronic Signature: The term “electronic signature” shall be construed to mean any form of electronic signature, including but not limited to, a graphical, hand written representation using a signature capture device, a password, or such other electronic data input.

Electronic Data: The term “electronic data” shall be construed to mean any form of electronic data input, including but not limited to: an electronic signature, biometric data, source code, passwords, graphics, audio and other such electronic data.

As to a further discussion of the manner of usage and operation of the present invention, the same should be apparent from the above description. Accordingly, no further discussion relating to the manner of usage and operation will be provided. It is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed:

1. A method and system for providing and performing electronic notary services; said method and system comprising: the internet or other TCP/IP (Transmission Control Protocol/Internet Protocol) based network, a local computer system, a desktop manager, a host computer system, an electronic document repository, an electronic document, notarization processes and methods, an electronic signature input device, an electronic notary seal input device, and an electronic notary journal; said method and system further comprising the steps of:
a. a customer using said local computer system to access a website maintained by said host computer system;
b. said customer using said local computer system to select notarization services;
c. said customer using said local computer system to access said electronic document repository;
d. said customer using said local computer system to download said electronic document from said electronic document repository to said customer local computer system;
e. said customer using said customer local computer system to input information into said electronic document, if desired;
f. said customer using said customer local computer system to upload said electronic document to said electronic document repository from said customer local computer system;
g. said host computer system assigning a temporary signing password to said electronic document;
h. said host computer system notifying the signatory required to sign said electronic document when said electronic document is ready for signature, and furnishing said signatory said temporary signing password;
i. said signatory accessing a notary public, whereby said notary public downloads said electronic document from said electronic document repository using said temporary signing password; said temporary signing password haven been given to said notary public by said signatory;
j. said electronic signature input device obtaining the electronic, manual, handwritten signature of said signatory;
k. said desktop manager simultaneously affixing said electronic, manual, handwritten signature of said signatory to said electronic document;
l. said electronic signature input device obtaining the electronic, manual, handwritten signature of said notary public,
m. said desktop manager simultaneously affixing said electronic, manual, handwritten signature of said notary public to said electronic document;
n. said electronic notary seal input device affixing an electronic notary seal to said electronic document;
o. said desktop manager executing said rules-based integrity check to verify said electronic notary seal is authentic;
p. said desktop manager recording said notarization processes and methods in said electronic notary journal;
q. said desktop manager terminating said temporary signing password and encrypting said electronic document;
r. said notary public uploading said electronic document to said electronic document repository;
s. said host computer system executing said rules-based integrity check; and
t. said host computer system archiving said electronic document for future use, reference or retrieval.

2. The method of claim 1 whereby said customer using said customer local computer system accesses said host computer system via the Internet or other TCP/IP based network to further access a website located on the world-wide-web; said website being a function of said host computer system.

3. The method of claim 1 whereby said customer using said customer local computer system accesses said host computer system via the internet or other TCP/IP based network to further access a client-system infrastructure; said client-system infrastructure being a function of said host computer system.

4. The method of claim 1 whereby said customer local computer system of said notary public further comprises said desktop manager; said document manager further comprising the means for said customer local computer system of said notary public to interface with said host computer system, said electronic document repository, said electronic document, said rules-based integrity check, said notarization processes and methods, said electronic signature input device, said electronic notary seal input device, and said electronic notary journal.

5. The method of claim 1 whereby said notary public establishes a registration account with said electronic transaction manager, whereby said notary public inputs verification information to establish said registration account.

6. The method of claim 1 whereby said electronic document repository further comprises a variety of said electronic documents and a plurality of said electronic documents; said electronic documents being represented by category or by type of said electronic document.

7. The method of claim 1 whereby said host computer system further comprises the means to assign a unique code or reference number to each said electronic document stored in said electronic document repository; said code or said reference number being registered in said electronic transaction manager database for internal management and tracking of said electronic document.

8. The method of claim 1 whereby said host computer system further comprises the means whereby said customer local computer system may access said electronic document repository and select said electronic document or a plurality of said electronic document for download to said customer local computer system.

9. The method of claim 1 whereby an image of said electronic document is displayed on the browser of said customer local computer system; said image being a graphical representation of the hard copy paper document said electronic document replaces.

10. The method of claim 1 whereby an image of said electronic document is displayed on the browser of said customer local computer system; said image being a text representation of the hard copy paper document said electronic document replaces.

11. The method of claim 1 whereby said host computer system further comprises the means whereby said access password assigned to said electronic document is disseminated to signatory.

12. The method of claim 1 whereby said host computer system further comprises the means whereby said signatories may access multiples copies of said electronic document singularly, or simultaneously, from said electronic document repository; said multiple copies of said electronic document being identical in form and substance, for notarization.

13. The system of claim 26 whereby said host computer system further comprises the means whereby said signatures input singularly and simultaneously into said copies of said electronic document is compiled into a single electronic document by the host computer system.

14. The method of claim 1 whereby said host computer system further comprises the means whereby a signing password is assigned to said electronic document for retrieval from said electronic document repository; each of said signatories' said access password being individual and unique.

15. The method of claim 1 whereby said host computer system further comprises the means to notify the signatory that said electronic document is ready for signature and the means to disseminate said temporary signing password to said signatory.

16. The method of claim 1 whereby said desktop manager further comprises the means whereby said notary public downloads said electronic document from said electronic document repository using said customer local computer system and said temporary signing password supplied by said signatory.

17. The method of claim 1 whereby said desktop manager further comprises the means whereby a graphical image of said electronic document is displayed on the browser of said customer local computer system; said graphical image being a representation of the hard copy paper document said electronic document replaces.

18. The method of claim 1 whereby said desktop manager further comprises the means whereby said desktop manager highlights or otherwise indicates each place in said electronic document where the electronic signature of said signatory is to be input into said electronic document.

19. The method of claim 1 whereby said signatory inputs said electronic signature into said electronic document using said electronic signature input device; and whereby said desktop manager affixes said electronic signature in the designated places of said electronic document.

20. The method of claim 1 whereby said notary public inputs said electronic signature into said electronic document using said electronic signature input device; and whereby said desktop manager affixes said electronic signature in the designated places of said electronic document.

21. The system of claim 1 whereby said electronic signature input device may be a remote device, and whereby said electronic signature appears as a graphical representation of said signatory's manual, hand-written signature.

22. The system of claim 1 whereby said electronic signature input device may be a function of said customer local computer system, and whereby said electronic signature appears as a graphical representation of said signatory's manual, hand-written signature.

23. The system of claim 1 whereby said electronic signature input device may be a remote device; and whereby said electronic signature of said signatory appears in the form of electronic code.

24. The system of claim 1 whereby said electronic signature input device may be a function of said customer local computer system; and whereby said electronic signature of said signatory appears in the form of electronic code.

25. The method of claim 1 whereby said desktop manager further comprises the means whereby said desktop manager highlights or otherwise indicates each place in said electronic document where the electronic signature of said notary public is to be input into said electronic document.

26. The system of claim 1 whereby said desktop manager further comprises the means whereby a separate electronic signature is required for each place said electronic signature is required in said electronic document; and whereby said desktop manager will not replicate said electronic signature should multiple electronic signatures be required from said signatory.

27. The method of claim 1 whereby said desktop manager further comprises the means whereby said desktop manager highlights or otherwise indicates each place where an electronic notary seal is to be input into said electronic document.

28. The method of claim 1 whereby said electronic notary seal input device further comprises the means whereby said notary public affixes said electronic notary seal to said electronic document where indicated by said desktop manager.

29. The system of claim 1 whereby said desktop manager further comprises said rules-based integrity check, whereby said electronic notary seal input device must match a secure code embedded in said desktop manager in order to affix said electronic notary seal to said electronic document.

30. The system of claim 1 further comprising the means whereby said electronic notary seal may appear as a graphical representation on said electronic document. or may appear in the form of an electronic barcode on said electronic document.

31. The system of claim 1 further comprising the means whereby said electronic notary seal may appear in the form of an electronic barcode on said electronic document.

32. The method of claim 1 whereby said rules-based integrity check of said desktop manager further comprises the means to authenticate said electronic notary seal by matching the verification information embedded in said notary seal input device to said registration account of said notary public maintained by said host computer system.

33. The method of claim 1 whereby said desktop manager further comprises said electronic notary journal function; said electronic notary journal further comprising the information required by the governing law of the state or country that regulates said notary public, to legally enforce said notarization processes and methods.

34. The system of claim 1 further comprising the means whereby upon said notary public affixing said electronic notary seal to said electronic document, said desktop manager executes said notary journal, whereby an independent electronic notary journal record of said notary public is created on said customer local computer system of said notary public.

35. The method of claim 1 whereby said desktop manager further comprises the means to terminate said temporary signing password upon said desktop manager creating said independent electronic notary journal record.

36. The method of claim 1 whereby said desktop manager further comprises the means to encrypt electronic document in order to prohibit any changes being made to said electronic document.

37. The method of claim 1 whereby said desktop manager further comprises the means whereby said notary public uploads said electronic document to said electronic repository.

38. The method of claim 1 whereby said host computer system further comprises the means to archive said electronic document for future use or retrieval.

39. A method and system for providing and performing electronic notary services; said method and system comprising: said internet or other TCP/IP (Transmission Control Protocol/Internet Protocol) based network, said customer local computer system, said desktop manager, said host computer system, said electronic document repository, said electronic document, said notarization processes and methods, said electronic signature input device, said electronic notary seal input device, and said electronic notary journal; said method and system further comprising the steps of:
a. a customer using said local computer system to access a website maintained by said host computer system;
b. said customer using said local computer system to select notarization services;
c. said customer using said local computer system to access said electronic document repository;
d. said customer using said local computer system to upload said electronic document from said customer local computer system to said electronic document repository;
e. said host computer system assigning a temporary signing password to said electronic document;
f. said host computer system notifying the signatory required to sign said electronic document when said electronic document is ready for signature, and furnishing said signatory said temporary signing password;
g. said signatory accessing said notary public, whereby said notary public downloads said electronic document from said electronic document repository using said temporary signing password; said temporary signing password haven been given to said notary public by said signatory;
h. said electronic signature input device obtaining the electronic, manual, handwritten signature of said signatory;
i. said desktop manager simultaneously affixing said electronic, manual, handwritten signature of said signatory to said electronic document;
j. said electronic signature input device obtaining the electronic, manual, handwritten signature of said notary public;
k. said desktop manager simultaneously affixing said electronic, manual, handwritten signature of said notary public to said electronic document;
l. said electronic notary seal input device affixing an electronic notary seal to said electronic document;
m. said desktop manager executing said rules-based integrity check to verify said electronic notary seal is authentic;
n. said desktop manager recording said notarization processes and methods in said electronic notary journal;
o. said desktop manager terminating said temporary signing password and encrypting said electronic document;
p. said notary public uploading said electronic document to said electronic document repository;
q. said host computer system executing said rules-based integrity check; and
r. said host computer system archiving said electronic document for future use, reference or retrieval.

40. The method of claim 39 whereby said customer using said customer local computer system accesses said host computer system via the Internet or other TCP/IP based network to further access a website located on the world-wide-web; said website being a function of said host computer system.

41. The method of claim 39 whereby said customer using said customer local computer system accesses said host computer system via the internet or other TCP/IP based network to further access a client-system infrastructure; said client-system infrastructure being a function of said host computer system.

42. The method of claim 39 whereby said customer local computer system of said notary public further comprises said desktop manager; said document manager further comprising the means for said customer local computer system of said notary public to interface with said host computer system, said electronic document repository, said electronic document, said rules-based integrity check, said notarization processes and methods, said electronic signature input device, said electronic notary seal input device, and said electronic notary journal.

43. The method of claim 39 whereby said notary public establishes a registration account with said electronic transaction manager, whereby said notary public inputs verification information to establish said registration account.

44. The method of claim 39 whereby said electronic document repository further comprises a variety of said electronic documents and a plurality of said electronic documents; said electronic documents being represented by category or by type of said electronic document.

45. The method of claim 39 whereby said host computer system further comprises the means to assign a unique code or reference number to each said electronic document stored in said electronic document repository; said code or said reference number being registered in said electronic transaction manager database for internal management and tracking of said electronic document.

46. The method of claim 39 whereby said host computer system further comprises the means whereby said customer local computer system may access said electronic document repository and select said electronic document or a plurality of said electronic document for download to said customer local computer system.

47. The method of claim 39 whereby an image of said electronic document is displayed on the browser of said customer local computer system; said image being a graphical representation of the hard copy paper document said electronic document replaces.

48. The method of claim 39 whereby an image of said electronic document is displayed on the browser of said customer local computer system; said image being a text representation of the hard copy paper document said electronic document replaces.

49. The method of claim 39 whereby said host computer system further comprises the means whereby said access password assigned to said electronic document is disseminated to signatory.

50. The method of claim 39 whereby said host computer system further comprises the means whereby said signatories may access multiples copies of said electronic document singularly, or simultaneously, from said electronic document repository; said multiple copies of said electronic document being identical in form and substance, for notarization.

51. The system of claim 39 whereby said host computer system further comprises the means whereby said signatures input singularly and simultaneously into said copies of said electronic document is compiled into a single electronic document by the host computer system.

52. The method of claim 39 whereby said host computer system further comprises the means whereby a signing password is assigned to said electronic document for retrieval from said electronic document repository; each of said signatories' said access password being individual and unique.

53. The method of claim 39 whereby said host computer system further comprises the means to notify the signatory that said electronic document is ready for signature and the means to disseminate said temporary signing password to said signatory.

54. The method of claim 39 whereby said desktop manager further comprises the means whereby said notary public downloads said electronic document from said electronic document repository using said customer local computer system and said temporary signing password supplied by said signatory.

55. The method of claim 39 whereby said desktop manager further comprises the means whereby a graphical image of said electronic document is displayed on the browser of said customer local computer system; said graphical image being a representation of the hard copy paper document said electronic document replaces.

56. The method of claim 39 whereby said desktop manager further comprises the means whereby said desktop manager highlights or otherwise indicates each place in said electronic document where the electronic signature of said signatory is to be input into said electronic document.

57. The method of claim 39 whereby said signatory inputs said electronic signature into said electronic document using said electronic signature input device; and whereby said desktop manager affixes said electronic signature in the designated places of said electronic document.

58. The method of claim 39 whereby said notary public inputs said electronic signature into said electronic document using said electronic signature input device; and whereby said desktop manager affixes said electronic signature in the designated places of said electronic document.

59. The system of claim 39 whereby said electronic signature input device may be a remote device, and whereby said electronic signature appears as a graphical representation of said signatory's manual, hand-written signature.

60. The system of claim 39 whereby said electronic signature input device may be a function of said customer local computer system, and whereby said electronic signature appears as a graphical representation of said signatory's manual, hand-written signature.

61. The system of claim 39 whereby said electronic signature input device may be a remote device; and whereby said electronic signature of said signatory appears in the form of electronic code.

62. The system of claim 39 whereby said electronic signature input device may be a function of said customer local computer system; and whereby said electronic signature of said signatory appears in the form of electronic code.

63. The method of claim 39 whereby said desktop manager further comprises the means whereby said desktop manager highlights or otherwise indicates each place in said electronic document where the electronic signature of said notary public is to be input into said electronic document.

64. The system of claim 39 whereby said desktop manager further comprises the means whereby a separate electronic signature is required for each place said electronic signature is required in said electronic document; and whereby said desktop manager will not replicate said electronic signature should multiple electronic signatures be required from said signatory.

65. The method of claim 39 whereby said desktop manager further comprises the means whereby said desktop manager highlights or otherwise indicates each place where an electronic notary seal is to be input into said electronic document.

66. The method of claim 39 whereby said electronic notary seal input device further comprises the means whereby said notary public affixes said electronic notary seal to said electronic document where indicated by said desktop manager.

67. The system of claim 39 whereby said desktop manager further comprises said rules-based integrity check, whereby said electronic notary seal input device must match a secure code embedded in said desktop manager in order to affix said electronic notary seal to said electronic document.

68. The system of claim 39 further comprising the means whereby said electronic notary seal may appear as a graphical representation on said electronic document. or may appear in the form of an electronic barcode on said electronic document.

69. The system of claim 39 further comprising the means whereby said electronic notary seal may appear in the form of an electronic barcode on said electronic document.

70. The method of claim 39 whereby said rules-based integrity check of said desktop manager further comprises the means to authenticate said electronic notary seal by matching the verification information embedded in said notary seal input device to said registration account of said notary public maintained by said host computer system.

71. The method of claim 39 whereby said desktop manager further comprises said electronic notary journal function; said electronic notary journal further comprising the information required by the governing law of the state or country that regulates said notary public, to legally enforce said notarization processes and methods.

72. The system of claim 39 further comprising the means whereby upon said notary public affixing said electronic notary seal to said electronic document, said desktop manager executes said notary journal, whereby an independent electronic notary journal record of said notary public is created on said customer local computer system of said notary public.

73. The method of claim 39 whereby said desktop manager further comprises the means to terminate said temporary signing password upon said desktop manager creating said independent electronic notary journal record.

74. The method of claim 39 whereby said desktop manager further comprises the means to encrypt electronic document in order to prohibit any changes being made to said electronic document.

75. The method of claim 39 whereby said desktop manager further comprises the means whereby said notary public uploads said electronic document to said electronic repository.

76. The method of claim 39 whereby said host computer system further comprises the means to archive said electronic document for future use or retrieval.
